(19) United States
(12) Patent Application Publication
(10) Pub. No.: US 2009/0017846 A1
(43) Pub. Date: Jan. 15, 2009

(54) Bracelet for Text Messaging

(76) Inventor: Carol Lovelace, Linden, TX (US)

Correspondence Address: WILSON DANIEL SWAYZE, JR., 3804 CLEARWATER CT., PLANO, TX, 75025, US

(21) Appl. No.: 11/774,768

(22) Filed: Jul. 9, 2007

(51) Int. Cl. H04Q 7/20

(52) U.S. Cl. 455/466

(57) ABSTRACT

A bracelet for text messaging includes a circuit for entering a text message to be sent, a circuit for storing the text message to be sent, and a circuit for sending the text message. The bracelet can be worn around the leg or arm of the user. The bracelet includes a first arm for attaching to the user, and the bracelet includes a second arm for attaching to the user. The text message may be an emergency text message, and the text message includes a destination address. The destination address may be a dedicated destination address.

### FIELD OF THE INVENTION

This invention relates generally to generating and sending text messages, and more particularly, to an bracelet to be worn by the user and capable of sending text messages particularly in the case of emergency.

### BACKGROUND OF THE INVENTION

In recent years, wireless electronic devices, such as cellular telephones, have been becoming more and more popular as communication instruments due to their decreasing sizes and increasing mobility.

Recent events including recent shooting at schools and universities have shown the importance of relaying critical information to a large number of users such as students of the school or University. Many of today's students own and operate a cellular phone which may or may not include text messaging. However, the cell phones may be in use or not turned on, and consequently, they may be useless for receiving an emergency message. What is required is a device that is easily carried and can receive wireless text messaging. Furthermore, it is desirable that the device be dedicated connected to a home base so that the emergency message can be immediately sent and received by the user with a minimum amount of the delay. Furthermore, the device should have the capability of being able to transmit an emergency message to the home base when an emergency is detected.

U.S. Pat. No. 5,697,060 discloses a portable wireless voice message transmitter over packet switched network for transmitting a voice message. The transmitter is capable of transmitting a voice message and text-based information when a user makes an emergency call to a special address with which the text-based information is associated. The transmitter includes text-based information setting circuit for setting text-based information, a first memory for storing the text-based information, a special address setting circuit for setting a special address which is associated with the text-based information and a second memory for storing the special address. The transmitter also includes a microphone for inputting a voice message, a third memory for storing the voice message, a destination setting circuit for setting a destination, a transmission start key operable by a user for generating a transmission start signal and a transmitter circuit responsive to the transmission start signal for transmitting the voice message stored to the destination address. When the destination address is coincident with the special address stored in the first memory, the transmitter circuit transmits the text-based information as well as the voice message to the destination address so that the message recipient receives both the voice message and the text-based information.

U.S. Pat. No. 6,205,342 describes methods and apparatuses for composing text messages using wireless electronic devices, such as cellular telephones. Specifically, a word list including a set of pre-selected words and a set of dynamically updated words is stored in a cellular telephone. The words in the word list are then displayed on the cellular telephone in a circular fashion. A user can select the words displayed on the cellular telephone to compose a text message. To reflect word usage pattern of the user, the second set of words is updated based on text messages previously composed.

### SUMMARY

The present invention combines the text messaging technology to be incorporated into a bracelet so that the users will wear the bracelet and as a result, be in constant communication with the home base and other users.

A bracelet for text messaging includes a circuit for entering a text message to be sent, a circuit for storing the text message to be sent, and a circuit for sending the text message. The bracelet can be worn around the leg or arm of the user.

The bracelet includes a first arm for attaching to the user, and the bracelet includes a second arm for attaching to the user.

The text message may be an emergency text message, and the text message includes a destination address.

The destination address may be a dedicated destination address,

### BRIEF DESCRIPTION OF THE DRAWINGS

The invention may be understood by reference to the following description taken in conjunction with the accompanying drawings, in which, like reference numerals identify like elements, and in which:

FIG. 1 illustrates the system of the present invention;

FIG. 2 illustrates electrical components of the present invention;

FIG. 3 illustrates a circuit diagram of the present invention;

FIG. 4 illustrates the bracelet of the present invention;

FIG. 5 illustrates a flow chart of the present invention;

FIG. 6 illustrates the bracelet of the present invention being worn by a user.

### DETAILED DESCRIPTION

FIG. 4 illustrates a bracelet 400 incorporating the text messaging technology within the housing 402 of the portable bracelet transmitter/receiver terminal and being attachable to the arm or leg of the user by the flexible arms 404. In other embodiments, the arms 404 may not be flexible

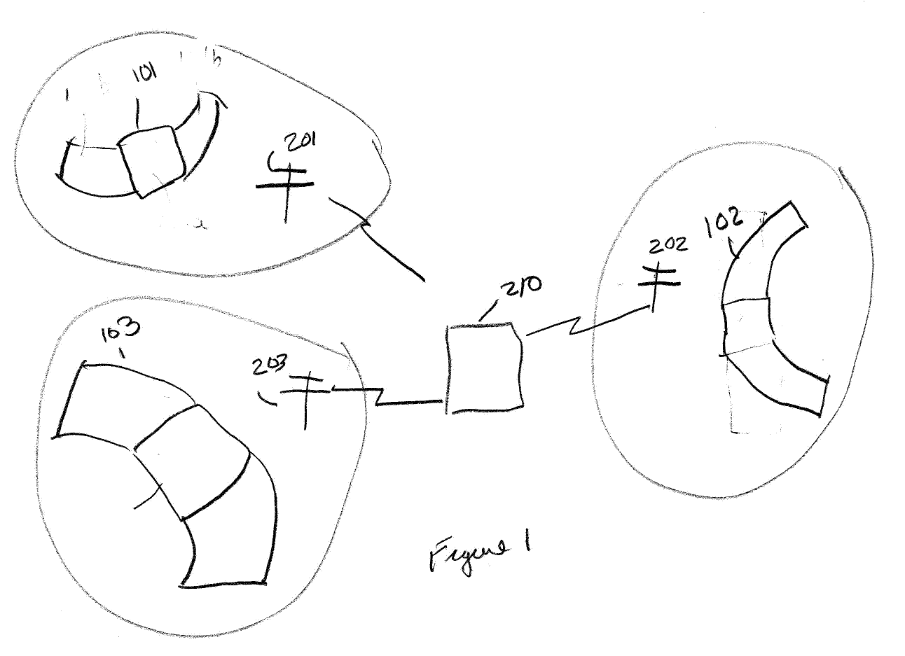

FIG. 1 shows a wireless text messaging system of the present invention. Portable bracelet transmitter/receiver terminals 101, 102, 103 are provided for users. If a user of bracelet terminal 101 wants to send a text message to another user of bracelet terminal 102, the user of bracelet terminal 101 inputs a text message through a the text setting console and sets a destination address specifying bracelet terminal 102 as a destination. The destination address could be preset or dedicated so that the destination address could not be changed, and all the individuals within a particular organization such as a school or university are notified. Bracelet terminal 101 modulates the input text message and transmits a modulated message as well as the destination address to a base station 201 which covers an area where bracelet terminal 101 is located. The terminal 101 transmitting the text message may be a computer or cell phone or any other device capable of text messaging with only the bracelet terminal receiving the text message. The modulated text message and the destination address are transmitted over the air as packet data.

Base station 201 receives the packet data transmitted from bracelet terminal 101 and transfers the received packet data to a network switching control center 210. Network switching control center 210 sends the packet data to a destination base station 202 which covers an area where the destination bracelet terminal 102 is located. The area could be a school or university. Base station 202 transmits the packet data over the air to the destination bracelet terminal 102 in accordance with the destination address included in the packet data. The destination terminal could be a cell phone or other device which could display the text message. When bracelet terminal 102 receives a complete text message, a beep, vibration or other conventional notification tells the user of bracelet terminal 102 of arrival of a new incoming message. The user of the bracelet terminal 102 can retrieve the new incoming message when he/she reproduces it through a display on the bracelet terminal 102.

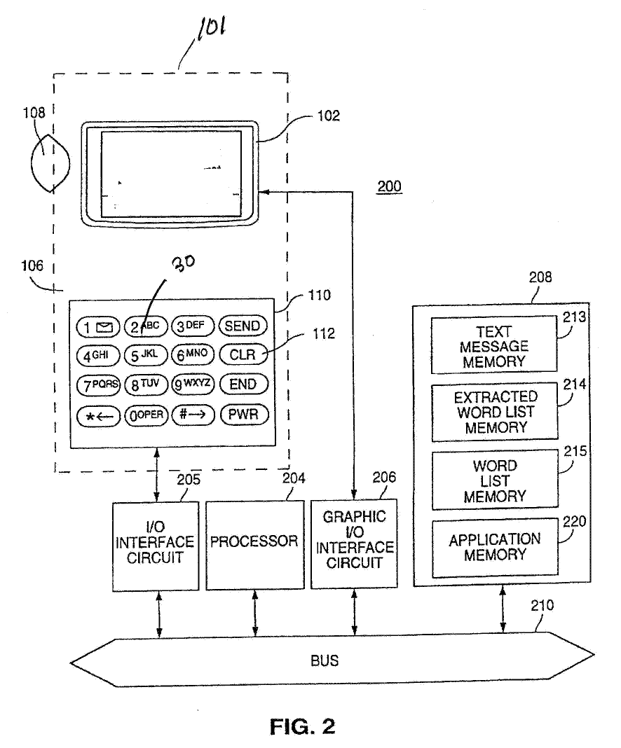

FIG. 2 shows a block diagram 200 to illustrate some components of the bracelet terminal 101, 102, 103 shown in FIG. 1 in accordance with the present invention.

The block diagram 200 includes a processor 204, an I/O (input and output) interface circuit 205, a graphic I/O interface circuit 206, a memory 208, and a bus 210. The processor 204, the I/O interface circuit 205, the graphic I/O interface circuit 206, and the memory 208 are all coupled to the bus 210.

The memory 208 includes: (1) a text message memory 213 for storing the text message composed by a user, (2) an extracted word list memory 214 for storing the words extracted from a composed text message, (3) a word list memory 215 for storing a word list, and (4) an application memory 220 for storing an application to compose text messages in accordance with the present invention.

The processor 204 controls the operations of the I/O interface circuit 205, the graphic I/O interface circuit 206, the memory 208, and the display region 102. More specifically, the processor 204 is able to: (1) get access to the text message memory 213, the extracted word list memory 214, and the word list memory 215, (2) interact with the control panel 106 via the interface circuit 205, (3) display the words contained in the word list memory 215 on the display region 102 via the graphic I/O interface circuit 206, (4) execute the application stored in the application memory 220 to compose a text message, and to form an extracted word list by extracting the words from the composed text message, and (5) store the composed text message in the text message memory 215, and the extracted word list in the extracted word list memory 214.

In response to a user's movement of the jog dial wheel 108 or a user's press of any key 30 on the key panel 110, the control panel 106 generates a request signal, which is in turn sent to the processor 204 via the I/O interface circuit 205. In response, the processor 204 executes the application stored in the application memory 220, thereby performing a particular function for the request signal. New text words can be generated by the keyboard 30.

The text message is transmitted to a corresponding base station as described above in conjunction with FIG. 1 and alternatively in conjunction with a voice message of the user.

The display 102 selectively displays a destination address and other text-based information as the user selects.

After a desired destination address is set, the user pushes send key to transmit the text message.

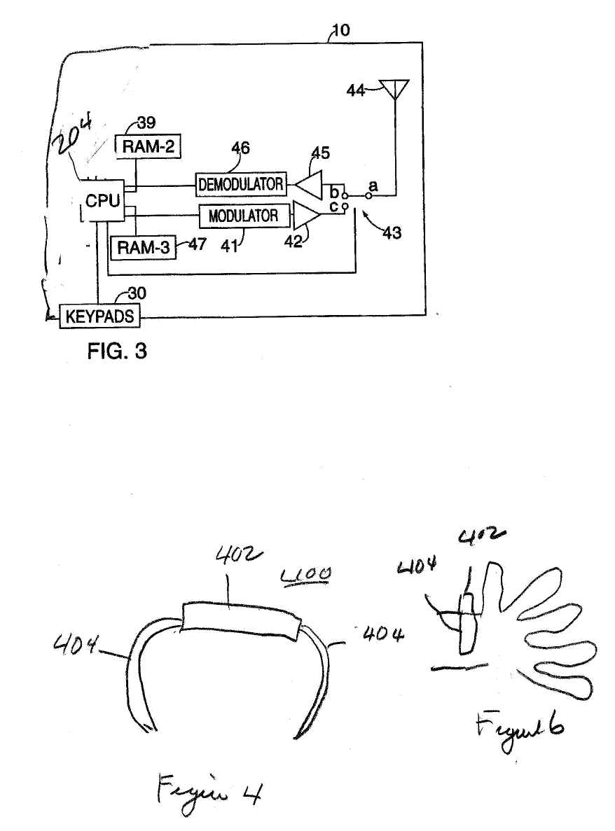

FIG. 3 is a block diagram showing an embodiment of internal circuits of transmitter/receiver terminal 10. FIG. 3 illustrates an antenna 44 for receiving and broadcasting text messages. A text message is received and the switch 43 is set to connect amplifier 45 to the antenna 44. The amplifier 45 amplifies the received signal and transmits it to the demodulator circuit 46 where the text message is demodulated. The CPU/processor 204 stores the text message in RAM-2 39 to be displayed to the user. Once a text message has been generated for transmission, the CPU/processor 204 transmits the text message from the RAM-3 47 to the modulator circuit 41 wherein the text message is modulated and transmitted to amplifier 42 where the text messages are amplified and connected to be transmitted to the antenna 44 by the switch 43.

In addition to sending a text message, the user can also set in advance text-based information associated with a special address which could be a default or dedicated address. If the user is a member of a university, for example, he/she may have the universities emergency number registered in the address list stored in RAM-2 39. Associated with the emergency number of the University, the user can set any information as text-based information. By using the cursor keys and the up/down keys in keypads 30, the user inputs various text-based information. The default/emergency message could be stored. The text-based information thus inputted is stored in RAM-3 47. After the user finishes setting the text-based information, he pushes the enter key in keypad 30. LCD display 16 is then switched to an address setting mode. The user sets a special address with which the text-based information is associated, either by setting a new address or by recalling one of the addresses stored in RAM-2 39.

When the user encounters an emergency situation at the school or university and needs immediate assistance. The user may use the dedicated address of the University for a text message and may use a predefined text message to be sent. In this way, the message can be quickly sent and the emergency message can be distributed to the school community.

When the user pushes the send key in keypads 30, CPU/processor 204 supplies to modulator 41 the encoded data read from RAM-1 35, the address of the school read from RAM-2 39 and the associated text-based information read from RAM-3 47. Modulator 41 supplies a modulated signal to amplifier 42 and the amplified signal is transmitted from antenna 44. As described above, when the user makes an emergency call, he need not do anything to retrieve and send the text-based information. Transmission of the text-based information associated with the special address is automatically done whenever the special address is chosen as a destination address.

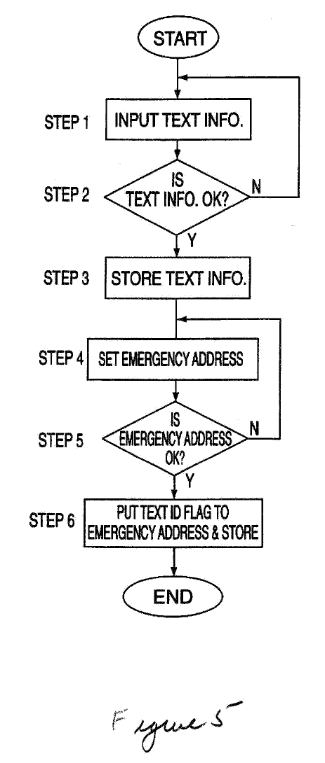

FIG. 5 is a flow-chart to explain the steps of setting text-based information associated with a special address. A user first inputs text-based information in step 1. Such text-based information may include a unique message or a predefined message or the user may modify a predefined message. These are the information to be communicated. The format of this information may be ASCII, but a special format may also be acceptable. In step 2, while watching the input text-based information on a display, the user determines whether the input text-based information is satisfactory. If the user is not satisfied with the text-based information, he goes back to step 1 and inputs new text-based information. If the user is satisfied with the text-based information, the text-based information is stored in a text memory in step 3.

After the user sets the text-based information, he sets a special address to which the text-based information is transmitted. In step 4, the user sets a special address either by inputting a new address or by recalling one of the addresses from the address list stored in an address memory. In step 5, the user determines whether the special address is correctly set. If the special address is not correctly input, the user goes back to step 4 and enters a special address correctly. If it is determined in step 5 that the special address is correctly set, in step 6 the special address is stored in the text message memory and is associated with the special address. The same text-based information may be associated with several special addresses.

After the correct destination address is set, the user can push a send key at any time.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

1) A bracelet for text messaging, comprising:
a circuit for entering a text message to be sent;
a circuit for storing the text message to be sent;
a circuit for sending the text message;
wherein the bracelet can be worn around the leg or arm of the user.

2) A bracelet for text messaging as in claim 1, when the bracelet includes a first arm for attaching to the user.

3) A bracelet for text messaging as in claim 2, wherein the bracelet includes a second arm for attaching to the user.

4) A bracelet for text messaging as in claim 1, wherein the text message is an emergency text message.

5) A bracelet for text messaging as in claim 1, wherein the text message includes a destination address.

6) A bracelet for text messaging as in claim 5, wherein the destination address is a dedicated destination address.
